(19) United States
(12) Patent Application Publication
(10) Pub. No.: US 2006/0188074 A1
(43) Pub. Date: Aug. 24, 2006

(54) Telecommunications services apparatus and method

(76) Inventor: Jeffrey Wilson, Hampshire (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/550,674

(22) PCT Filed: Mar. 19, 2004
(86) PCT No.: PCT/GB04/01224

§ 371 Date: Sep. 26, 2005

(30) Foreign Application Priority Data
Mar. 26, 2003 (GB) 0306937.4

(51) Int. Cl. H04M 1/64

(52) U.S. Cl. 379/67.1

(57) ABSTRACT

In a text message processing system, an SMS router (3) can recognise a predefined arrangement of one or more characters, such as “*”, as a suffix to a destination address of a message being submitted by a mobile telephone (1) to the system. Upon such recognition, a function required by the message sender is selected so as to change the normal delivery function, for example by forwarding the received message to an email interface (6) for delivery by email either instead of, or in addition to, normal text message delivery.

This invention relates to telecommunications services apparatus and methods, in the context of telecommunication networks and in particular messaging services such as text messaging services.

An example of such a text messaging facility is used in the GSM mobile telephone system. In GSM, the Short Message Services (SMS) allow Mobile Stations (MS) to send and receive short text messages. The messages are normally routed via a Short Message Service Centre (SMSC), which provides a store and forward function. The SMSC will attempt to deliver each message to its destination, which may be another MS or a host address in the same or another network.

Successful standardisation has permitted the global spread of mobile telecommunication networks. Handsets are manufactured that can be used in many networks in many countries. However, the standardisation process also slows down the introduction of new features in networks, and facilities available to users today are to a large extent constrained by the scope of the designs envisaged by those who formed the standards several years previously. Consequently some services or network facilities that are desirable today are not immediately available because their use was not previously envisioned during standardisation. Nevertheless it is still possible to introduce new services because of the richness and flexibility of those features that are available. Also, existing services can be used in new or specific ways to provide alternative behaviour and provide new services.

Text messaging has undergone enormous growth because it fulfils a basic communication need, complementing voice communication with the ability to send and receive short text messages. Text messaging is taken here as a generic term that includes similar forms of messaging including SMS, EMS, MMS and the like. Text messaging in GSM, using SMS, was primarily aimed at handset-to-handset communication, or network to handset communication for the purpose of alerting.

The extensive use of text messaging today for communication gives rise to a need for associated services that allow text message communication to provide some additional features that are taken for granted with other forms of communication. For example voice communication can support call recording and written communication allows photocopying, while text messaging has very little support for any form of copying or archiving, and none that is easy to use.

One technology that can be used as part of a beneficial service is the integration of Short Message and email. It would be desirable to have an easy way to specify that a text message be delivered to an email address as well or instead of being delivered to a telephone address, and this mechanism could then be used as a means of archiving text messages. It is possible in GSM today to send an SMS message that is delivered as an email, but this requires the sender to know the email address that relates to the desired destination, to format the message in a specific way to identify the email address within the body of a text message and to remember a different service number to which to send the message. Given all of these separate actions by the sender, the network is then capable of directing a text message to an email address. The complexity of the presently available model, and the differences from everyday text messaging, render the service little used in its present form. In any case the service does not provide for a copy of a message to be delivered to an email in addition to normal text message delivery, it merely delivers an email.

Embodiments of the present invention provide a simple way for users to obtain an archive copy of text messages, without them having to remember or enter any special service number.

According to one aspect of the invention there is provided telecommunications services apparatus for use with a telephone messaging system, the apparatus comprising means for recognising a predefined arrangement of one or more characters as a suffix to a destination address of a message being submitted to the telephone messaging system, and means responsive to recognition by the recognising means to select a function required by the sender of the message so as to change the normal message delivery function thereby to change or augment the processing or routing of the message.

According to another aspect of the invention there is provided a telecommunications services method in a telephone messaging system, the method comprising recognising a predefined arrangement of one or more characters as a suffix to a destination address of a message being submitted to the telephone messaging system, and selecting a function required by the sender of the message upon recognition of the suffix so as to change the normal message delivery function thereby to change or augment the processing or routing of the message.

According to further aspects of the invention there are provided a computer program for carrying out the above method, and a storage medium on which such computer program is stored.

Preferably, the changed or augmented message delivery function is operative to forward the message in appropriate format to an alternative delivery means.

Also, the changed or augmented message delivery function may be operative to forward the message in appropriate format to an additional delivery means, thereby providing an archive or copy function.

According to an embodiment of the invention, the alternative or additional delivery means utilises a pre-selected email address.

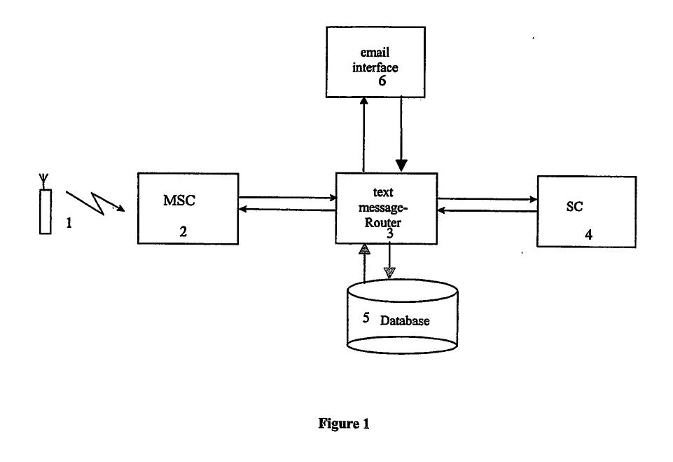

The invention will now be described by way of example with reference to the accompanying drawing (FIG. 1) which shows a block diagram of telecommunications services apparatus according to an embodiment of the invention.

FIG. 1 shows an embodiment of one aspect of the invention suitable for a GSM network that may be used to implement a changed message delivery function that is operative to copy information in appropriate format to a pre-selected email address. A mobile station (MS) 1 is connected to a telephone network and is associated with a mobile switching centre (MSC) 2. A text message router 3 is operable to intercept messages transmitted between the MSC 2 and a message service centre (SC) 4. An attached database 5 allows the router 3 to look up email addresses from telephone numbers. The router 3 is connected to an email interface 6 that is able to format and transmit messages as email.

The text message router 3 may, for example, be a Telsis (RTM) SMS Router, manufactured by Telsis Limited. This equipment is capable of connection to mobile telephone networks using known and standardised signalling postcards such as SS7 and TCP/IP

Text messages transmitted towards the message service centre SC 4 are directed via the text message router 3 using well known routing techniques. For example the switching centres (MSCs) in a GSM network may typically be programmed to perform global title translation on short messages so that these messages are routed to the text message router instead of directly to a service centre. In this way all messages destined for the service centre are sent via the text message router. In a practical realisation, several routers may be required. The router 3 examines the destination address of each message to determine whether one of a set of specific text suffices is present at the end of the address. The router 3 may also use source or destination address information to filter the messages so that only a certain subset of messages that pass through the router 3 have their destination addresses processed to check for suffices. This would be advantageous in reducing the processing load on the router 3, for example in situations where a proportion of text messages passing through the router 3 are destined for certain types of SMS host applications such as voting, where message processing according to this technique may not be applicable.

The router 3 examines messages passing through the router 3 that are deemed applicable to the message processing function. If a recognised suffix is not present on the destination address of the message, then the message is routed on transparently to its destination by normal means.

If a specific suffix is present, then the suffix is removed, and the router 3 causes the message to be processed in a manner that is specified by the particular suffix detected. Examples of the types of modified processing include copying to a second mobile destination, conversion and archiving of a copy of the message to an email destination and the like.

An example application is now described in detail, where the particular modification performed by the embodiment of the invention causes an archive copy of the message to be delivered by email in addition to text message delivery by normal means.

Text messages transmitted towards the message service centre SC 4 are intercepted by the text message router 3. The router 3 examines the destination address of each message to determine whether a specific text suffix is present. In this embodiment, the single character text suffix ‘¤’ is used to indicate an archive request. The GSM specifications, for example, specifically provide for the encoding of the ¤, #, A, B and C DTMF digits in dialled numeric strings which permits the present technique to utilise a ‘*’ suffix which will be transported between the mobile telephone 1 and the text message router 3.

For example the user might send the message to the MSISDN number 07777 123456* where the particular suffix used is a ‘*’. If the suffix is not present, then the message is routed on transparently to its destination by normal means. If the suffix is present, the router 3 accesses the attached database 5 to determine an associated email address for the sender of the message, by using the originating address. The suffix is removed and the resultant message is both routed on to its destination by normal means and also converted to email at the email interface 6 for delivery to the associated email address. In the preferred embodiment, if no associated address is available, then the email part of the delivery is not performed.

The database 5 provides a mapping between originating MSISDN numbers, such as are specified in the text message, and email addresses. The association between email address and telephone number may be user-provisioned by means of a text message service, a web interface or the like. If a mapping exists in the database 5, the message and the email address are passed to the email interface 6, formatted as an email and transmitted to the defined email address via an external data network. If mapping does not exist in the database 5, the sender may optionally be informed by a text message, or by a modified acknowledgement to his transmission or by other means.

The user does not need to remember his email address or enter it into the telephone, other than when originally provisioning it. If the address is not present, invalid, or otherwise unusable, then an error message may be returned to the sender, and the text message is simply passed on as though the suffix had not originally been present. Messages arriving at the router 3 with no suffix are passed transparently to the normal delivery means.

In an alternative embodiment, archiving to email in the manner described may be configured, either by the operator or by user provisioning, as the default case. A ‘*’ or other suffix on the destination address may then be used to disable rather than to enable the archiving feature. The archive provisioning status of each subscriber to a network may be stored in a provisioning database.

The provisioning of the default state of archiving as being either ON or OFF has the added advantage that it opens the possibility of archiving messages on behalf of the recipient as well as the sender, provided that the recipient is a subscriber of the same network. Hence, in an alternative embodiment, messages may be sent to an email address associated with the recipient as well as an email address associated with the sender.

If a recipient, who is a subscriber of the same network, has his default archiving state set to ON, then the text message router 3 may, by examination of the provisioning database, determine from the destination address that the recipient desires that all his received messages from other subscribers of the same network shall be archived. The text message router 3 may then undertake the email address lookup and email delivery of the message as described on behalf of the recipient. Similarly, the text message router 3 may, by examination of the provisioning database and with due regard for any destination address suffix that the user may have sent, determine from the originating address that the sender desires that this transmitted message shall be archived. The text message router 3 may then undertake the email address lookup and email delivery of the message as described on behalf of the sender.

In an alternative embodiment, a destination address suffix may be used by the sender to indicate that archiving is to be performed on behalf of the recipient, or on behalf of both the sender and the recipient. For example the two character suffix ‘**’ could be used to request archiving to the associated email addresses of both the sender and recipient, if available.

Provisioning of email addresses to the database 5 may be carried out in several ways. In a preferred embodiment, a text message formatted according to a predefined syntax may be sent to a predefined number e.g. a shortcode. This would cause the message to be terminated by the text message router 3 and the database 5 to be updated with the subscriber's CLI and the given email address. In an embodiment comprising more than one router, the database 5 could be shared between routers. In this case the database 5 may be connected indirectly to the routers, for example via a text Service Control Point (SCP.)

In another embodiment, database provisioning may be carried out via a web interface.

The present technique is distinct from a previously-proposed method, which makes use of text keys in the message body to modify message processing. This has the disadvantage that message capacity is consumed, which is not the case with the present technique.

A key attribute of the technique is that the described services and other like functions can be invoked on behalf of the sender or the recipient without the sender having to know any special telephone numbers. Traditionally these types of services would be implemented by the sender dialling a specific different number for each feature and interacting with a service. In the present technique the message is always directed at the recipient's telephone number with the addition of a simple memorable suffix such as ‘*’.

A similar principle may be applied to dialled telephone numbers for voice calls. By appending a * to the dialled number, the ‘archive’ feature may be invoked by the network in the form of voice call recording with the possibility of emailing the resultant file to either the originator, the recipient or both.

In so far as the embodiments of the invention described above may be implemented, at least in part, using software-controlled processing apparatus, it will be appreciated that a computer program providing such software control and a storage medium by which such a computer program is stored are envisaged as aspects of the invention.

1-34. (canceled)

35. Telecommunications services apparatus for use with a telephone messaging system, the apparatus comprising means for recognising a predefined arrangement of one or more characters as a suffix to a destination address of a message being submitted to the telephone messaging system, and means responsive to recognition by the recognising means to select a function required by the sender of the message so as to change the normal message delivery function thereby to change or augment the processing or routing of the message, wherein the function selecting means comprises a message router selectively operable to divert messages away from a message service centre of the messaging system.

36. Apparatus according to claim 35, wherein the function selecting means is operable, upon recognition by the recognising means, to forward the received message to an alternative delivery means.

37. Apparatus according to claim 36, wherein the alternative delivery means provides an archive or copy function.

38. Apparatus according to claim 36, wherein the alternative delivery means includes means for translating the received message into email form, and means for delivering the translated message in email form.

39. Apparatus according to claim 36, wherein the alternative delivery means may be operable to forward the received message to more than one destination.

40. Apparatus according to claim 36, wherein the alternative delivery means is operable to forward the message to the sender of the message.

41. Apparatus according to claim 36, wherein the alternative delivery means is operable to forward the message to the message recipient.

42. Apparatus according to claim 36, wherein the function selecting means is operable both to send the message by the normal delivery function, and also to send the message by the alternative delivery means.

43. Apparatus according to claim 42, wherein the function selecting means is operable to remove the suffix from the destination address before sending the message by the normal delivery function.

44. Apparatus according to claim 36, wherein the function selecting means is operable to send the message by the alternative delivery means only.

45. Apparatus according to claim 36, wherein the function selecting means has a default setting for sending the message both by the normal delivery function and also by the alternative delivery means, and recognition of the suffix is operable to override the default setting so as to override the normal delivery function.

46. Apparatus according to claim 35, wherein the function selecting means has a default setting for change of the normal message delivery function, and recognition of the suffix is operable to override the default setting.

47. Apparatus according to claim 36, including a database storing destination addresses for the alternative delivery means.

48. Apparatus according to claim 47, wherein the database is operable to map between caller identifiers and the destination addresses for the alternative delivery means.

49. Apparatus according to claim 35, wherein the function selecting means may be provisioned by receipt of a message.

50. Apparatus according to claim 35, wherein the function selecting means may be provisioned via a web interface.

51. A telecommunications services method in a telephone messaging system, the method comprising recognising a predefined arrangement of one or more characters as a suffix to a destination address of a message being submitted to the telephone messaging system, and selecting a function required by the sender of the message upon recognition of the suffix so as to change the normal message delivery function thereby to change or augment the processing or routing of the message, wherein a message router performs the function selecting step by selectively diverting messages away from a message service centre of the messaging system.

52. A method according to claim 51, wherein the selected function forwards the received message to an alternative delivery means.

53. A method according to claim 52, wherein the alternative delivery means provides an archive or copy function.

54. A method according to claim 52, wherein the alternative delivery means translates the received message into email form, and delivers the translated message in email form.

55. A method according to claim 52, wherein the alternative delivery means may forward the received message to more than one destination.

56. A method according to claim 52, wherein the alternative delivery means forwards the message to the sender of the message.

57. A method according to claim 52, wherein the alternative delivery means forwards the message to the message recipient.

58. A method according to claim 52, wherein the message is sent both by the normal delivery function and by the alternative delivery means.

59. A method according to claim 58, wherein the suffix is removed from the destination address before sending the message by the normal delivery function.

60. A method according to claim 52, wherein the message is sent by the alternative delivery means only.

61. A method according to claim 52, wherein recognition of the suffix in a received message overrides a default setting for sending the message both by the normal delivery function and also by the alternative delivery means, so as to override the normal delivery function.

62. A method according to claim 51, wherein recognition of the suffix in a received message overrides a default setting for change of the normal message delivery function.

63. A method according to claim 52, wherein destination addresses for the alternative delivery means are stored in a database.

64. A method according to claim 63, wherein the database maps between caller identifiers and the destination addresses for the alternative delivery means.

65. A method according to claim 51, wherein function selection may be provisioned by receipt of a message.

66. A method according to claim 51, wherein function selection may be provisioned via a web interface.

67. A computer program for implementing a method according to claim 51.

68. A storage medium storing a computer program according to claim 67.
